(19) United States
(12) Patent Application Publication
(10) Pub. No.: US 2009/0278472 A1
(43) Pub. Date: Nov. 12, 2009

(54) METHOD AND SYSTEM FOR A NETWORK OF WIRELESS BALLAST-POWERED CONTROLLERS

(76) Inventors: Jerry Mills, Boulder, CO (US); Brian Empey, Delta (CA)

Correspondence Address: MERCHANT & GOULD PC, P.O. BOX 2903, MINNEAPOLIS, MN, 55402-0903, US

(21) Appl. No.: 12/117,592

(22) Filed: May 8, 2008

(51) Int. Cl. H05B 41/36

(52) U.S. Cl. 315/294

(57) ABSTRACT

Autonomous lighting subsystems include ballast-powered wireless nodes for receiving control signals to control lighting devices. Autonomous lighting subsystems may be networked with other autonomous lighting subsystems to control various building-devices, including but not limited to lighting ballasts, occupancy sensors, daylight harvesters, and building automation control devices.

### TECHNICAL FIELD

The invention relates generally to wireless building control systems, and more particularly to a network of wireless ballast-powered controllers used to control electrical or electro-mechanical systems in buildings.

### BACKGROUND

A building control system generally allows a building operator to control a building system within one or more buildings, such as an HVAC system (heating, ventilation, and air conditioning system), a lighting system, a water and waste system, or a security system. For example, a building control system may include a centralized or remote building control station from which a building operator may configure thermostat setting schedules and monitor temperatures in various building zones. In this manner, a building operator can manage energy use and tenant comfort in accordance with the anticipated building usage during various hours of the day.

Various open systems standards for building control system networks, such as the BACnet® and LonWorks® systems, have become important tools of the building control industry by providing data communication protocols for building automation and control networks. Using protocols such as BACnet® and LonWorks®, a building operator can control and monitor building-related devices or endpoints distributed throughout a building. Such protocol-compliant devices may include without limitation furnaces, air conditioning systems, cooling towers, heat exchangers, lighting systems, dampers, actuators, sensors, security cameras, and other building-related devices.

More recently, building control systems have incorporated wireless networking in the form of data communication protocols, including but not limited to wireless mesh networks such as ZigBee® systems. In many cases, wireless building control systems provide greater flexibility for installing, controlling and monitoring building-related devices. Wireless building control systems typically permit building operators to employ low-cost and/or low-power control devices (or endpoints) that may increase the number of build-related devices that can be controlled and monitored and improve the overall management of a building. Despite improving the management of building controls, wireless building control systems typically require building operators to install separate power lines to each endpoint control device or continuously replace batteries within each of the endpoint control devices. The cost necessary to install and/or maintain wireless building control systems may be significant and exceed the costs a building operator might otherwise incur to install and/or maintain a wired building control system.

### SUMMARY OF THE INVENTION

Against this backdrop systems and methods have been developed for providing a network of wireless ballast-powered controllers. The wireless controllers (or wireless nodes) are connected to ballasts that provide the wireless controllers with power. The wireless controllers may be networked with other networkable controllers (including other wireless ballast-powered controllers), lighting ballasts, and other building-related devices, including but not limited to daylight harvesters and occupancy sensors. The wireless ballast-powered controllers may implement one or more wired or wireless data communication protocols, including but not limited to BACnet®, LonWorks®, or ZigBee® data communication protocols, and may include multiple inputs and outputs. The wireless ballast-powered controllers include control logic for delivering a control signal and/or power signal to one or more other networkable controllers, lighting ballasts, and/or other building-related ancillary devices. The network of wireless ballast-powered controllers may permit reduction of light levels and power consumption (e.g., using load-shedding applications) within a building.

These and various other features as well as advantages will be apparent from a reading of the following detailed description and a review of the associated drawings. Additional features are set forth in the description which follows, and in part will be apparent from the description, or may be learned by practice of the described embodiments. While it is to be understood that both the foregoing general description and the following detailed description are exemplary and explanatory, the benefits and features will be realized and attained by the structure particularly pointed out in the written description and claims hereof as well as the appended drawings.

### BRIEF DESCRIPTION OF THE DRAWINGS

The following drawing figures, which form a part of this application, are illustrative of embodiments systems and methods described below and are not meant to limit the scope of the invention in any manner, which scope shall be based on the claims appended hereto.

FIG. 1 illustrates an exemplary network of autonomous lighting subsystems.

FIG. 2 illustrates another exemplary network of autonomous lighting subsystems.

FIG. 3 illustrates an exemplary logical representation of a wireless node.

FIG. 3 illustrates another exemplary logical representation of a wireless node.

FIG. 5 illustrates an exemplary flow diagram for networking an autonomous lighting subsystem.

### DETAILED DESCRIPTION OF EMBODIMENTS OF THE INVENTION

The following detailed description is intended to convey a thorough understanding of the embodiments described by providing a number of specific embodiments and details involving systems and methods for networking an autonomous lighting subsystem. It should be appreciated, however, that the claims appended hereto are not limited to these specific embodiments and details, which are exemplary only. It is further understood that one possessing ordinary skill in the art, in light of known systems and methods, would appreciate the applicability of this disclosure for its intended purposes and benefits in any number of alternative embodiments, depending upon specific design and other needs.

A wireless ballast-powered controller (also referred to as a “wireless node”) may be networked with other networkable wireless nodes, other power controllers (e.g., wired nodes), lighting ballasts, and user-controlled voltage selectors to provide a lighting control network. A wireless node may be used in combination with or be coupled to other control devices or components, including dimmer controls, occupancy sensors, daylight harvesters, demand load shedder component(s), and photometers, to provide a number of flexible embodiments of the present invention. The wireless node includes a communications interface that may be integrated within the control logic of the wireless node. The communications interface permits the wireless node to receive communications from a wireless gateway. Wireless nodes may be positioned within various logical configurations (or subsystems) of a lighting system. Each of the lighting subsystems may operate autonomously in response to communications received from the wireless gateway.

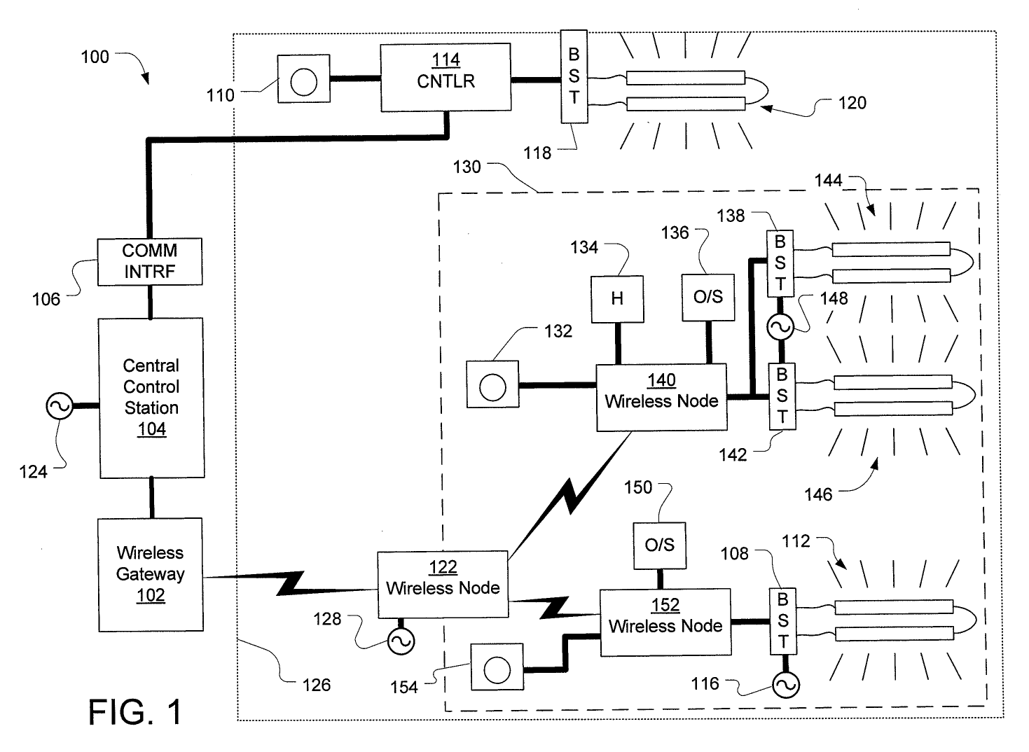

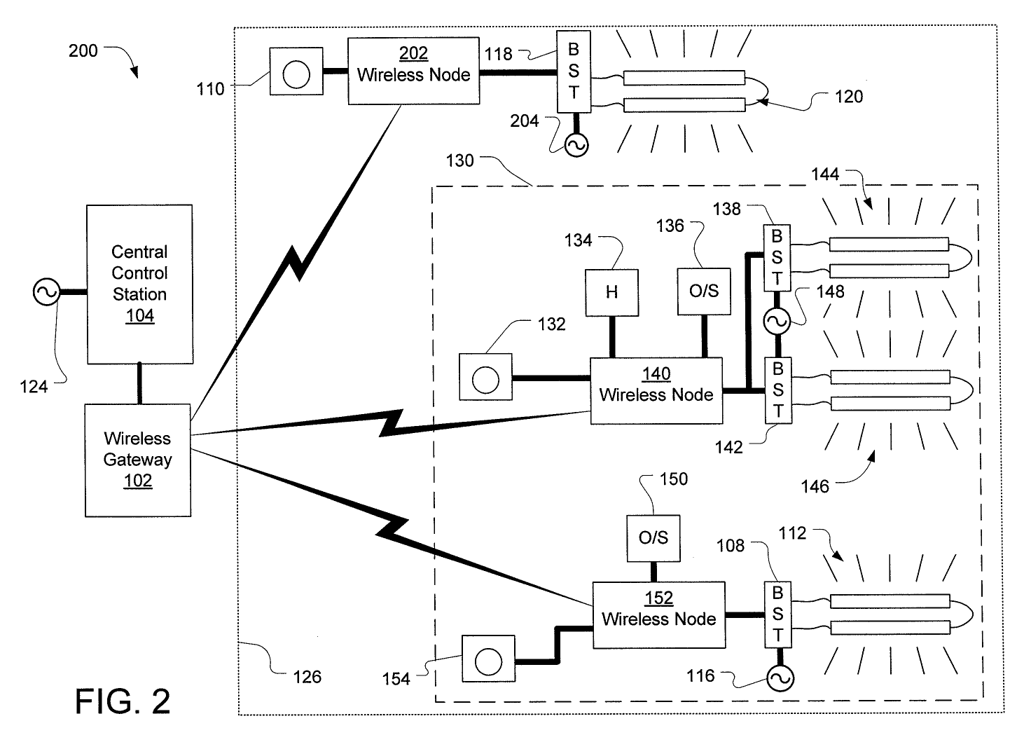

FIG. 1 illustrates an exemplary embodiment of a network 100 of autonomous lighting subsystems. It should be understood that alternative network topologies may be configured without departing from the scope of this disclosure and the claims appended hereto. The combination of power lines, ground lines and control lines are indicated in FIG. 1, and other figures, as thick black lines. As illustrated in FIG. 1, a network 100 may be comprised of wired and wireless lighting subsystems. Alternatively, as illustrated in FIG. 2, a network 200 may be solely comprised of wireless lighting subsystems. In the network 100, a central control station 104 communicates lighting instructions in the form of a digital signal to and from a communications interface 106 and wireless gateway 102. As illustrated, the central control station 104 may receive current from an independent power source 124. The central control station 104 may generate or pass along commands to control various building-devices, such as lighting devices 120, 144. 146, and 112. The illustrated embodiment shows a typical fluorescent lamp 120 including two gas discharge bulbs coupled in series to a ballast (BST) 118. It should be understood that the fluorescent lamp 120 is illustrated as a lighting device in an exemplary embodiment of the present invention and that alternative lighting devices, including other gas discharge lamps, may be employed within the scope of the present invention. Examples of alternative lighting devices include high intensity discharge (HID) lamps, sodium lamps, and neon lamps.

The communications interface 106 (COMM INTRF) converts the digital signal from the central control station 104 into an analog control signal that satisfies the wired signaling protocol of the lighting controller 114. A dimmer control 110 may be coupled to the lighting controller 114. In one embodiment, a dimmer control 110 is a user-interface device for adjusting a light level (or dimming level) and may be comprised of, but is not limited to, a rotary knob, slide-control, or one or more push-buttons. Within the network 100, lighting controllers may be cascaded together to provide scalability and control of lighting devices distributed throughout a building.

The lighting controllers in a network may be viewed as controllable nodes in the network. Examples of controlling a wired network of lighting controllers using mode selection control to pass or gate a wired control signal to the next controller or output power device downstream from the controller may be found in U.S. Pat. No. 6,400,103, filed Mar. 10, 2000, entitled “Networkable Power Controller,” and incorporated herein by reference. As set forth in FIG. 1, a network 100 may further be comprised of wireless nodes 122, 140, and 152 that may comprise one or more lighting subsystems 130.

In FIG. 1, central control station 104 is further connected to a wireless gateway 102. Wireless gateway 102 may take many forms, including but not limited to a wireless router or wireless access point (WAP). The wireless gateway 102 may wirelessly communicate with a wireless node 122 at the entry to a logical subsystem 130 of the network. The lighting subsystem 130 may include a variety of building devices, including but not limited to additional wireless nodes 140 and 152, ballasts 138, 142, and 108, lighting devices 144, 146, and 112, occupancy sensors 136 and 150, dimmers 132 and 154, and a daylight harvester 134. Dimmers 132 and 154 may override the lighting instructions received, respectively, by wireless nodes 140 and 152. In another embodiment, a wireless dimmer (not shown) may itself supply lighting instructions to wireless nodes 140 and 152 that instruct the wireless nodes 140 and 152 to vary the current supplied by ballasts 138, 142, and 108 to lighting devices 144, 146, and 112. A wireless node 122 may act as an intermediary to relay or pass along lighting instructions from the wireless gateway 102 to additional wireless nodes 140 and 152 acting as endpoints within the lighting subsystem 130. Alternatively, as described with respect to FIG. 2, a wireless gateway 102 may wirelessly communicate directly with wireless nodes 140 and 152 within the lighting subsystem 130.

Wireless node 140 controls two ballasts 138 and 142, where each ballast drives lighting devices 144 and 146 respectively. Wireless node 152 controls ballast 108 which drives or varies current supplied to lighting device 112. Outside the lighting subsystem 130, lighting controller 114 controls ballast 118 which in turn varies the current supplied to lighting device 120. Controller 114 receives a wired control signal from the central control station 104. In one embodiment, lighting controller 114 and wireless nodes 140 and 152 provide control signals to frequency controlled dimming ballasts 118, 138, 142, and 108 which may control the power consumption of lighting devices 120, 144, 146, and 112 (e.g., gas discharge lamps) by varying the electrical power applied to the lighting devices in response to the control signals. A frequency controlled dimming ballast may use a loosely-coupled transformer that controls the conduction of current to the lighting device in response to an oscillating driving signal. A more detailed discussion of a frequency-controlled dimming ballast may be found in U.S. patent application Ser. No. 08/982,975, filed Dec. 2, 1997, entitled “Frequency Controlled, Quick and Soft Start Gas Discharge Lamp Ballast and Method Therefor” and U.S. patent application Ser. No. 08/982,974, filed Dec. 2, 1997, entitled “Frequency Controller with Loosely Coupled Transformer Having A Shunt With A Gap And Method Therefor”, incorporated herein by reference. Ballasts other than those described in the related patents may be used with the controllers described herein.

When the network is viewed at a building or site level, the illustrated embodiment of FIG. 1 represents an exemplary configuration of a building's lighting controller network. As such, the building's lighting controller network may be logically sub-divided into lighting subsystems that may, for example, correspond to one or more rooms and/or floors within the building (e.g., a lighting subsystem 126 may correspond to lighting devices occupying one floor of a building). The central control station 104, through the communications interface 106 and wireless gateway 102, provides lighting instructions to the various controllers 114 and wireless nodes 122, 140, and 152 within the network 100. The central control station 104 may provide scheduled illumination changes throughout the day or week (e.g., after midnight, the lights in the building are dimmed to a minimal level).

In an embodiment, each ballast 118, 138, 142, and 108 is powered by conventional AC power source 124, 148, and 116 and has its own power supply or power factor circuit to generate DC power. The power factor circuit may include a winding and circuitry from which DC power is derived to provide auxiliary DC power outside the ballast. An example of a ballast providing auxiliary DC power outside the ballast may be found U.S. Patent 5,933,340, issued August 3, 1999, entitled “Frequency Controller with Loosely Coupled Transformer Having A Shunt With A Gap And Method Therefor.”

FIG. 2 illustrates another exemplary embodiment of a network 200 of autonomous lighting subsystems. As discussed earlier, it should be appreciated that alternative network topologies may be configured without departing from scope of this disclosure and the claims appended hereto. As illustrated in FIG. 2, many of the elements in network 200 are common to the network 100 illustrated in FIG. 1. As such, reference is made to FIG. I for all elements in common between networks 100 and 200 and not specifically discussed with respect to FIG. 2.

As illustrated in FIG. 2, a network 200 may be comprised entirely of wireless nodes 202, 140, and 152 in communication with a wireless gateway 102. The wireless nodes 202, 140, and 152 may operate autonomously from the central control station 104 such that each of the wireless nodes 202, 140, and 152 derives its power, respectively and exclusively, from the power 204, 148, and 116 supplied to ballasts 118, 138, 142, and 108. Providing power to wireless nodes 202, 140, and 152 via ballasts 118, 138, 142, and 108 permits building operators to install and maintain lighting subsystems without having to install and maintain separate power supply lines or power supplies (e.g., battery-power) for the wireless nodes 202, 140, and 152. By removing the physical wired connections otherwise necessary for the central control station 104 to control building devices, such as lighting devices 120, 144, 146, and 112, a network 200 may be autonomously configured into logical divisions (i.e., subsystems) by a building operator.

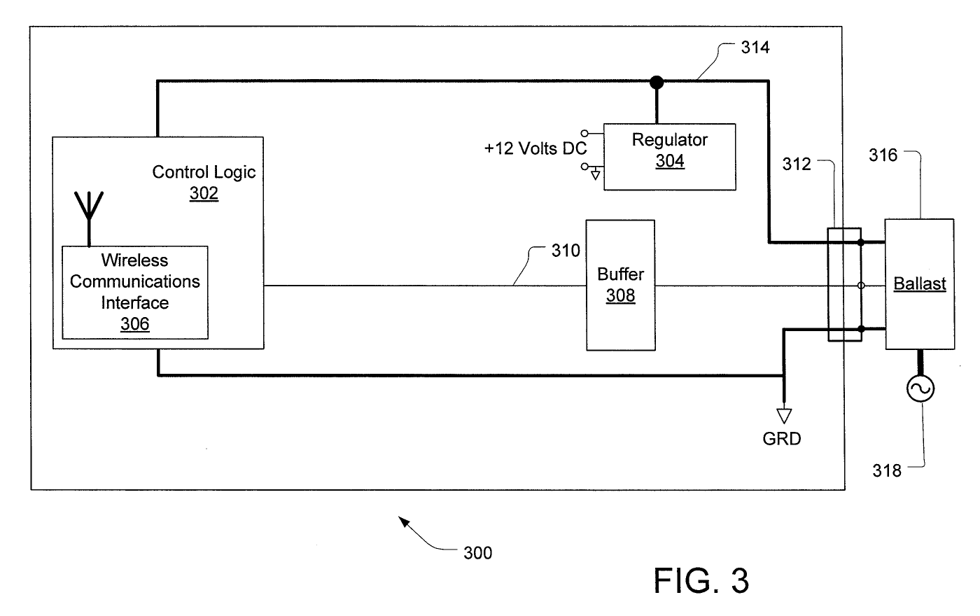

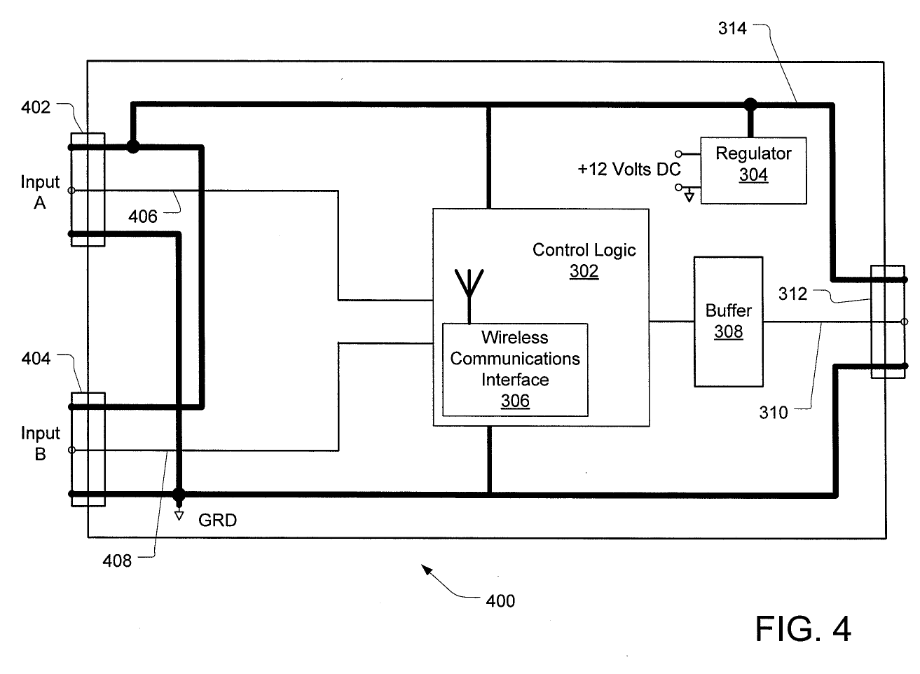

FIG. 3 illustrates an exemplary logical representation of an embodiment of a wireless node 300. As illustrated, a wireless node 300 preferably includes a connection interface 312, a buffer 308, a regulator 304, control logic 302 and a wireless communications interface 306.

In an exemplary embodiment, the wireless communications interface 306 of a wireless node 300 may be integrated within the control logic 302 of the wireless node. The control logic 302 and the wireless communications interface 306 may each include various computing components and/or circuitry, including but not limited to microprocessors, D/A and/or A/D converters, and memory. As described previously, the wireless node 300 may receive lighting instructions from a central control station. The wireless communications interface 306 may also be adapted to receive lighting instructions from another control device, including but not limited to another wireless node (acting as a relay) or a handheld programmable device for programming the control logic 302. In coordination with the control logic 302, the wireless communications interface 306 receives and processes the lighting instructions. As a result of processing the lighting instructions, the control logic 302 may output a control signal 310 for controlling a device (e.g., a ballast) connected via the connection interface 312. The wireless node 300 may also include a buffer 308 for amplifying and isolating the control signal 310 provided by the control logic 302, as the control signal 310 may need to conform to a signaling protocol in order to control (i.e., drive) a subsequent wireless node, wired power controller, or ballast. A wireless node 300 may further include a regulator 304 that receives current from a power bus 314. As illustrated, a device (e.g., a self-powered ballast 316) connected via a connection interface 312 may provide power 318 to the wireless node 300.

The lighting instructions received by wireless communications interface 306 may be individually or uniquely addressable. For example, the wireless communications interface may be addressable using a Media Access Control (MAC) addresses. In alternative embodiments, other addressing means and a different number of unique addresses is contemplated within the scope of the present invention. Using addressing, individual wireless nodes 300, and thus associated building devices such as ballasts and lighting devices, may be logically grouped into lighting subsystems and controlled from a master digital controller, such as a computer or dedicated control unit at a central control station.

FIG. 4 illustrates another exemplary logical representation of an embodiment of a wireless node 400. As illustrated in FIG. 4, many of the components of wireless node 400 are common to wireless node 300 illustrated in FIG. 3. As such, reference is made to FIG. 3 for all elements in common between wireless nodes 300 and 400 and not specifically discussed with respect to FIG. 4.

As set forth in FIG. 4, a wireless node 400 may further include one or more ancillary ports 402 and 404. In an alternative embodiment, additional ancillary ports may be included within the wireless node. Each ancillary port may include a power lead, a ground lead, and control leads 406 and 408. Control leads 406 and 408 may receive a signal (e.g., an input signal), data or instructions that may provide lighting instruction information. An ancillary port may be used to couple the wireless node 400 to an ancillary control device, including but not limited to a daylight harvester, occupancy sensor, or an over-ride dimmer. Power may be delivered to the ancillary device via power bus 314. The power bus 314 may thus transfer power from the connection interface 312 through the controller to the ancillary ports 402 and 404. In this manner, power provided to the wireless node 400 (e.g., by a ballast) may be transferred to power ancillary devices (e.g., rotary controls, demand load shedders, communications interfaces, etc.) in the network. For example, in FIG. 2, wireless node 140 receives power from ballasts 138 and 142 and transfers power to occupancy sensor 136, daylight harvester 134, and dimmer 132.

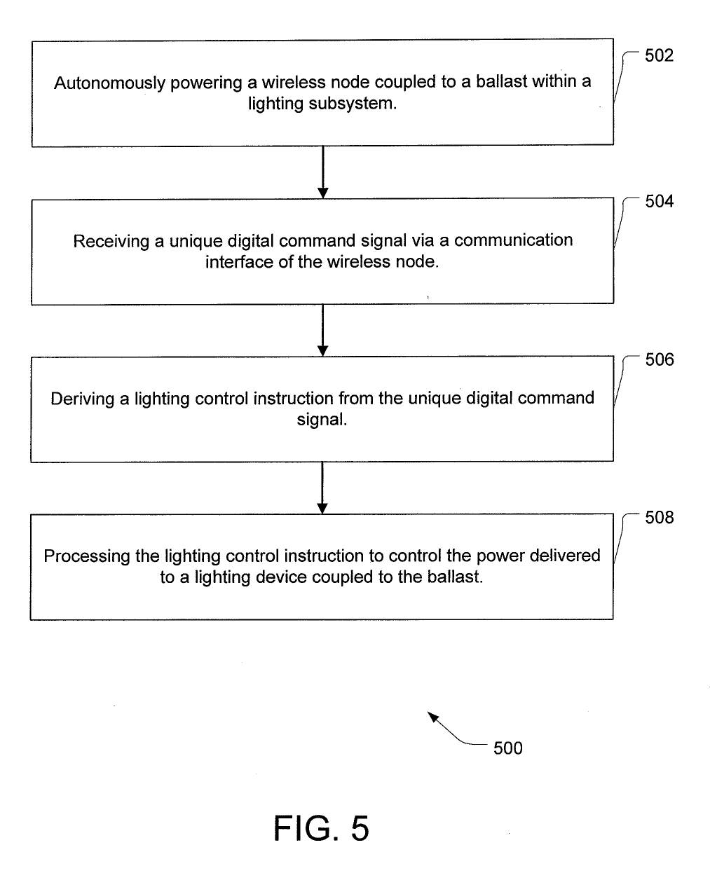

FIG. 5 illustrates an exemplary flow diagram for networking an autonomous lighting subsystem. In a powering operation 502, a wireless node is autonomously powered by coupling the wireless node to a ballast within a lighting subsystem. In a receiving operation 504, a communication interface of the wireless node receives a unique digital command signal. In one embodiment, the unique digital command signal may be addressable using a MAC address that uniquely identifies the wireless node. In a deriving operation 506, a lighting control instruction may be derived from the unique digital command signal. For example, the control logic of a wireless node may parse a signal received by the wireless communications interface and extract one or more lighting control instructions from the digital command signal. Finally, in a processing operation 508, the lighting control instruction is processed such that the instruction controls power to a lighting device coupled to the ballast. For example, the lighting control instruction may include a command to reduce or eliminate (e.g., dim or turn-off) power delivered by the ballast to the lighting device. In an alternative embodiment of the method 500, at least one wireless node may receive an input signal from an ancillary control device (e.g., a photometer, occupancy sensor, daylight harvester). At least a portion of this input signal may be transmitted by the at least one wireless node to a remote processing device. The remote processing device may then process the at least a portion of the input signal to derive one or more lighting instructions. The remote processing device may then transmit to the at least one wireless node the one or more lighting instructions in the form of a unique digital command signal.

The embodiments described herein may be implemented as logical steps in one or more computer systems. The logical operations may be implemented (1) as a sequence of processor-implemented steps or program modules executing in one or more computer systems and (2) as interconnected machine modules or logic modules within one or more computer systems. The implementation is a matter of choice, dependent on the performance requirements of the computer system implementing the invention. Accordingly, the logical operations making up the embodiments of the invention described herein are referred to variously as operations, steps, objects, or modules.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client or server or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure. For example, the central control station may itself incorporate a wireless gateway such that lighting instructions are delivered directly to each of the wireless node endpoints comprising any lighting subsystem. Moreover, the central control station may be configured such that each of the wireless node endpoints may communicate back to the central control station. In this case, each of the wireless node endpoints may then provide data obtained from ancillary devices to the central control station. As another example, one or more of the wireless node endpoints may store or log data (e.g., energy consumption information such as output levels) and wirelessly provide the data to other devices (including but not limited to a wireless gateway, a central control station, and/or other ancillary devices). The data may then be used to compute or provide alternative lighting instructions for communication back to the one or more wireless node endpoints. Numerous other changes may be made that will readily suggest themselves to those skilled in the art and which are encompassed in the spirit of the invention disclosed and as defined in the appended claims.

1. A wireless lighting control system comprising:
a plurality of lighting control subsystems, each of the plurality of lighting control subsystems comprising:
a ballast coupled to a lighting device;
a power supply configured to supply power to the ballast; and
a wireless node coupled to the ballast, the wireless node receiving power from the ballast and configured to receive lighting control instructions that when processed control the lighting device by varying the supply of power supplied by the ballast to the lighting device.

2. The wireless lighting control system of claim 1, further comprising:
a wireless gateway configured to wirelessly distribute the lighting control instructions to the plurality of lighting control subsystems.

3. The wireless lighting control system of claim 1, wherein at least one of the plurality of lighting control subsystems further comprises:
an occupancy sensor coupled to the wireless node.

4. The wireless lighting control system of claim 1, wherein at least one of the plurality of lighting control subsystems further comprises:
a daylight harvester coupled to the wireless node.

5. The wireless lighting control system of claim 1, wherein at least one of the plurality of lighting control subsystems further comprises:
a dimmer coupled to the wireless node.

6. The wireless lighting control system of claim 1, wherein at least one of the plurality of lighting control subsystems further comprises:
a wireless dimmer that communicates with the wireless node.

7. The wireless lighting control system of claim 1 wherein the lighting control instructions are transmitted by a central control station to the wireless gateway.

8. The wireless lighting control system of claim 1 wherein the wireless node relays the lighting control instructions to a second wireless node within at least one of the plurality of lighting control subsystems.

9. The wireless lighting control system of claim 8 wherein the wireless node and the second wireless node are logically organized within the same lighting control subsystem.

10. The wireless lighting control system of claim 1 wherein processing of the lighting control instructions further configures the wireless node to operate at least one lighting control subsystem autonomously from another lighting control subsystem.

11. The wireless lighting control system of claim 1 wherein the power supply configuration to supply power to the ballast is separate from a control signal provided to the wireless node by the ballast.

12. The wireless lighting control system of claim 1 wherein the ballast is a frequency-controlled dimming ballast.

13. A method for networking an autonomous lighting subsystem comprising:
autonomously powering at least one wireless node within a lighting subsystem, the at least one wireless node being coupled to a ballast and receiving current from the ballast;
receiving a unique digital command signal via a communications interface of the at least one wireless node, the unique digital command signal being addressable to the at least one wireless node within the lighting subsystem;
deriving a lighting control instruction from the unique digital command signal, the lighting control instruction providing an instruction that when executed controls the power delivered by the ballast to a lighting device coupled to the ballast; and
processing the lighting control instruction to control the power delivered by the ballast to the lighting device coupled to the ballast.

14. The method of claim 13 wherein the unique digital command signal comprises a Media Access Control (MAC) address.

15. The method of claim 13 wherein autonomously powering the at least one wireless node comprises:
receiving current from the ballast that is separate from a control signal provided by the wireless node to the ballast to control the power delivered by the ballast to a lighting device coupled to the ballast.

16. The method of claim 13 wherein a processor within the at least one wireless node processes the lighting control instruction to control the power delivered by the ballast to the lighting device coupled to the ballast.

17. The method of claim 13 wherein processing further comprises:
processing an input signal provided to the at least one wireless node by an ancillary control device.

18. A method for networking an autonomous lighting subsystem comprising:
autonomously powering at least one wireless node within a lighting subsystem, the at least one wireless node being coupled to a ballast and receiving current from the ballast;
receiving by the at least one wireless node an input signal from an ancillary control device;
transmitting via the at least one wireless node at least a portion of the input signal to a remote processing device;
receiving from the remote processing device a unique digital command signal derived from the at least a portion of the input signal, the unique digital command signal being addressable to the at least one wireless node within the lighting subsystem;
deriving a lighting control instruction from the unique digital command signal, the lighting control instruction providing an instruction that when executed controls the power delivered by the ballast to a lighting device coupled to the ballast; and
processing the lighting control instruction to control the power delivered by the ballast to the lighting device coupled to the ballast.

19. A wireless lighting control subsystem comprising:
a ballast coupled to a lighting device;
a power supply configured to supply power to the ballast; and
a wireless node coupled to the ballast, the wireless node receiving power from the ballast and configured to receive lighting control instructions that when processed control the lighting device by varying the supply of power supplied by the ballast to the lighting device.
